(19) United States
(12) Patent Application Publication
(10) Pub. No.: US 2025/0105907 A1
(43) Pub. Date: Mar. 27, 2025

(54) MULTIPLE WAVEFORMS BASED QCL/TCI FRAMEWORK

(71) Applicant: Lenovo (Singapore) Pte. Ltd., New Tech Park (SG)

(72) Inventors: Ankit Bhamri, Rödermark (DE); Ali Ali, Kraiburg am Inn (DE); Sher Ali Cheema, Ilmenau (DE)

(21) Appl. No.: 18/290,949

(22) PCT Filed: Jul. 20, 2022
(86) PCT No.: PCT/IB2022/056717

§ 371 Date: Jan. 22, 2024

Related U.S. Application Data
(60) Provisional application No. 63/223,933, filed on Jul. 20, 2021.

(51) Int. Cl. H04B 7/06; H04L 27/26

(52) U.S. Cl. CPC H04B 7/06968; H04L 27/261

(57) ABSTRACT

Apparatuses, methods, and systems are disclosed for multiple waveforms based QCL/TCI framework. An apparatus (300) includes a transceiver (325) and a processor (305) that is configured to receive signaling information from a network, the signaling information indicating quasi-co-location (“QCL”) information comprising at least one source reference signal (“RS”) and at least one target RS for transmission to the network, reception from the network, or a combination thereof, and apply the QCL information at the apparatus (300) based on the one or more waveforms associated with the at least one source RS and the at least one target RS.

### CROSS-REFERENCE TO OTHER APPLICATIONS

This application claims the benefit of U.S. Provisional Patent Application No. 63/223,933, entitled “MULTIPLE WAVEFORMS BASED QCL/TCI FRAMEWORK” and filed on Jul. 20, 2021, for Ankit Bhamri et al., which is incorporated herein by reference.

### FIELD

The subject matter disclosed herein relates generally to wireless communications and more particularly relates to multiple waveforms based quasi colocation (“QCL”)/transmission configuration indicator (“TCI”) framework.

### BACKGROUND

One of the defining elements of any mobile communications system is the type of waveform used for the communication link in the radio access network for transmitting and receiving data.

### BRIEF SUMMARY

Disclosed are solutions for multiple waveforms based QCL/TCI framework. The solutions may be implemented by apparatus, systems, methods, or computer program products.

In one embodiment, a first apparatus includes a transceiver and a processor that is coupled to the transceiver. In one embodiment, the processor is configured to cause the apparatus to receive signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the processor is configured to cause the apparatus to apply the QCL information at the apparatus based on the one or more waveforms associated with the at least one source RS and the at least one target RS.

In one embodiment, a first method includes receiving signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the first method includes applying the QCL information at the apparatus based on the one or more waveforms associated with the at least one source RS and the at least one target RS.

In one embodiment, a second apparatus includes a transceiver and a processor that is coupled to the transceiver. In one embodiment, the processor is configured to cause the apparatus to determine signaling information indicating QCL information comprising at least one source RS and at least one target RS for transmission to a network, reception from the network, or a combination thereof, the at least one source RS and the at least one target RS associated with one or more waveforms. In one embodiment, the processor is configured to cause the apparatus to transmit the QCL information to a UE for application based on the one or more waveforms associated with the at least one source RS and the at least one target RS.

In one embodiment, a second method includes determining signaling information indicating QCL information comprising at least one source RS and at least one target RS for transmission to a network, reception from the network, or a combination thereof, the at least one source RS and the at least one target RS associated with one or more waveforms. In one embodiment, the second method includes transmitting the QCL information to a UE for application based on the one or more waveforms associated with the at least one source RS and the at least one target RS.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for multiple waveforms based QCL/TCI framework;

FIG. 2 is a diagram illustrating one embodiment of a NR protocol stack;

FIG. 3 is a block diagram illustrating one embodiment of a user equipment apparatus that may be used for multiple waveforms based QCL/TCI framework;

FIG. 4 is a block diagram illustrating one embodiment of a network apparatus that may be used for multiple waveforms based QCL/TCI framework;

FIG. 5 is a flowchart diagram illustrating one embodiment of a method for multiple waveforms based QCL/TCI framework; and

FIG. 6 is a flowchart diagram illustrating one embodiment of another method for multiple waveforms based QCL/TCI framework.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for multiple waveforms based QCL/TCI framework. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In Rel-19 or beyond, it is expected that new additional waveforms will be considered for new radio (“NR”) operation beyond 71 GHz. For downlink (“DL”), currently only cyclic prefix-orthogonal frequency division multiplexing (“CP-OFDM”) is supported. Any new waveform such a Discrete Fourier Transform spread OFDM (“DFT-s-OFDM”), single carrier-frequency domain equalization (“SC-FDE”), SC-quadrature amplitude modulation (“SC-QAM”), or some other single carrier waveforms are expected to be specified for 5G-Advanced in addition to CP-OFDM. This may impact how the measurements and reporting are done for different waveforms.

For example, if a measurement is done on a reference signal (“RS”) for an OFDM-based waveform, it is not expected that such measurement could be useful to determine the beam/channel/link quality for a single carrier waveform or vice-versa as each waveform may exhibit different channel behavior than other waveforms. Consequently, this can impact on how the QCL is performed between source and target RS depending up on waveform type. Therefore, in this disclosure, solutions are disclosed to handle this aspect of QCL/TCI enhancement for multi-waveform DL and/or uplink (“UL”), which does not allow the quasi-co-location of two RSs that may not be transmitted/received with the same waveform since different waveforms (e.g., single carrier or multi-carrier) might result in different parametrization of transmission/reception on channel/beams/radio link.

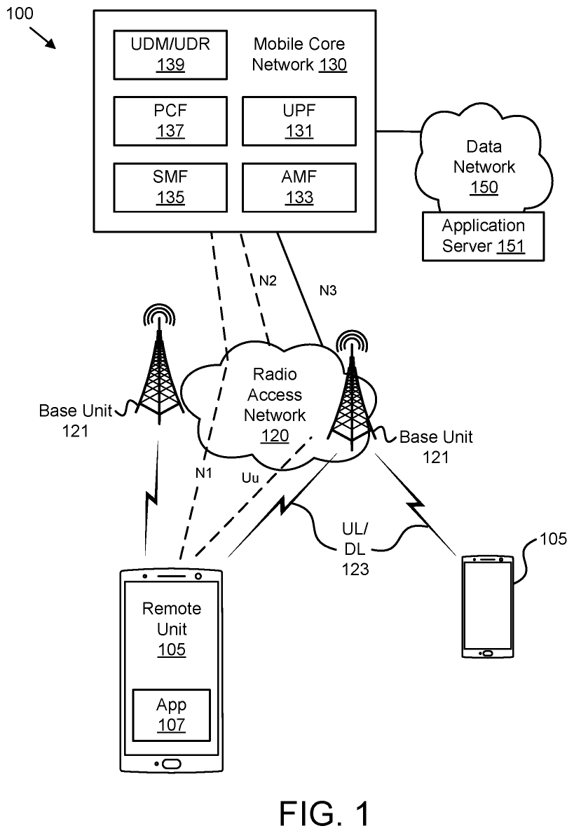

FIG. 1 depicts a wireless communication system 100 supporting CSI enhancements for higher frequencies, according to embodiments of the disclosure. In one embodiment, the wireless communication system 100 includes at least one remote unit 105, a radio access network (“RAN”) 120, and a mobile core network 130. The RAN 120 and the mobile core network 130 form a mobile communication network. The RAN 120 may be composed of a base unit 121 with which the remote unit 105 communicates using wireless communication links 115. Even though a specific number of remote units 105, base units 121, wireless communication links 115, RANs 120, and mobile core networks 130 are depicted in FIG. 1, one of skill in the art will recognize that any number of remote units 105, base units 121, wireless communication links 115, RANs 120, and mobile core networks 130 may be included in the wireless communication system 100.

In one implementation, the RAN 120 is compliant with the 5G system specified in the Third Generation Partnership Project (“3GPP”) specifications. For example, the RAN 120 may be a New Generation Radio Access Network (“NG-RAN”), implementing NR RAT and/or 3GPP Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Here, the RAN 120 is an intermediate network that provides the remote units 105 with access to the mobile core network 130.

In some embodiments, the remote units 105 communicate with an application server via a network connection with the mobile core network 130. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 130 via the RAN 120. The mobile core network 130 then relays traffic between the remote unit 105 and the application server (e.g., the content server 151 in the packet data network 150) using the PDU session. The PDU session represents a logical connection between the remote unit 105 and the User Plane Function (“UPF”) 131.

In order to establish the PDU session (or PDN connection), the remote unit 105 must be registered with the mobile core network 130 (also referred to as ‘“attached to the mobile core network” in the context of a Fourth Generation (“4G”) system). Note that the remote unit 105 may establish one or more PDU sessions (or other data connections) with the mobile core network 130. As such, the remote unit 105 may have at least one PDU session for communicating with the packet data network 150, e.g., representative of the Internet. The remote unit 105 may establish additional PDU sessions for communicating with other data networks and/or other communication peers.

In the context of a 5G system (“5GS”), the term “PDU Session” a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 130 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR-U operation, the base unit 121 and the remote unit 105 communicate over unlicensed radio spectrum.

In one embodiment, the mobile core network 130 is a 5GC or an Evolved Packet Core (“EPC”), which may be coupled to a packet data network 150, like the Internet and private data networks, among other data networks. A remote unit 105 may have a subscription or other account with the mobile core network 130. Each mobile core network 130 belongs to a single public land mobile network (“PLMN”). The present disclosure is not intended to be limited to the implementation of any particular wireless communication system architecture or protocol.

The mobile core network 130 includes several network functions (“NFs”). As depicted, the mobile core network 130 includes at least one UPF 131. The mobile core network 130 also includes multiple control plane (“CP”) functions including, but not limited to, an Access and Mobility Management Function (“AMF”) 133 that serves the RAN 120, a Session Management Function (“SMF”) 135, a Network Exposure Function (“NEF”), a Policy Control Function (“PCF”) 137, a Unified Data Management function (“UDM”) and a User Data Repository (“UDR”) 139.

The UPF(s) 131 is responsible for packet routing and forwarding, packet inspection, QoS handling, and external PDU session for interconnecting Data Network (“DN”), in the 5G architecture. The AMF 133 is responsible for termination of NAS signaling, NAS ciphering & integrity protection, registration management, connection management, mobility management, access authentication and authorization, security context management. The SMF 135 is responsible for session management (i.e., session establishment, modification, release), remote unit (i.e., UE) IP address allocation & management, DL data notification, and traffic steering configuration for UPF for proper traffic routing.

The NEF is responsible for making network data and resources easily accessible to customers and network partners. Service providers may activate new capabilities and expose them through APIs. These APIs allow third-party authorized applications to monitor and configure the network's behavior for a number of different subscribers (i.e., connected devices with different applications). The PCF 137 is responsible for unified policy framework, providing policy rules to CP functions, access subscription information for policy decisions in UDR.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 139.

In various embodiments, the mobile core network 130 may also include an Authentication Server Function (“AUSF”) (which acts as an authentication server), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 130 may include an authentication, authorization, and accounting (“AAA”) server.

In various embodiments, the mobile core network 130 supports different types of mobile data connections and different types of network slices, wherein each mobile data connection utilizes a specific network slice. Here, a “network slice” refers to a portion of the mobile core network 130 optimized for a certain traffic type or communication service. A network instance may be identified by a single-network slice selection assistance information (“S-NSSAI,”) while a set of network slices for which the remote unit 105 is authorized to use is identified by network slice selection assistance information (“NSSAI”).

Here, “NSSAI” refers to a vector value including one or more S-NSSAI values. In certain embodiments, the various network slices may include separate instances of network functions, such as the SMF 135 and UPF 131. In some embodiments, the different network slices may share some common network functions, such as the AMF 133. The different network slices are not shown in FIG. 1 for ease of illustration, but their support is assumed. Where different network slices are deployed, the mobile core network 130 may include a Network Slice Selection Function (“NSSF”) which is responsible for selecting of the Network Slice instances to serve the remote unit 105, determining the allowed NSSAI, determining the AMF set to be used to serve the remote unit 105.

Although specific numbers and types of network functions are depicted in FIG. 1, one of skill in the art will recognize that any number and type of network functions may be included in the mobile core network 130. Moreover, in an LTE variant where the mobile core network 130 comprises an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 133 may be mapped to an MME, the SMF 135 may be mapped to a control plane portion of a PGW and/or to an MME, the UPF 131 may be mapped to an SGW and a user plane portion of the PGW, the UDM/UDR 139 may be mapped to an HSS, etc.

While FIG. 1 depicts components of a 5G RAN and a 5G core network, the described embodiments apply to other types of communication networks and RATs, including IEEE 802.11 variants, Global System for Mobile Communications (“GSM”, i.e., a 2G digital cellular network), General Packet Radio Service (“GPRS”), UMTS, LTE variants, CDMA 2000, Bluetooth, ZigBee, Sigfox, and the like.

In the following descriptions, the term “gNB” is used for the base station but it is replaceable by any other radio access node, e.g., RAN node, eNB, Base Station (“BS”), Access Point (“AP”), NR, etc. Further the operations are described mainly in the context of 5G NR. However, the proposed solutions/methods are also equally applicable to other mobile communication systems supporting CSI enhancements for higher frequencies.

As background, regarding multiple waveform support for UL in NR, in NR Rel.15 UL, multiple waveforms are supported. gNB switches between multicarrier CP-OFDM and single carrier DFT-s-OFDM via radio resource control (“RRC”) configurations. The higher layer parameter transformPrecoder in pusch-Config configuredGrantConfig or msg 3-transformPrecoderin RACH-ConfigCommon provide the indication to enable or disable the transform pre-coder for physical uplink shared channel (“PUSCH”). The UE shall consider the transform precoding either ‘enabled’ or ‘disabled’ based on reading these messages, and the gNB applies simultaneous receptions of multiple UEs with different waveforms. Furthermore, switching between DFT-s-OFDM PUCCH, or other types of PUCCH waveforms, is indicated by the PUCCH format.

Regarding QCL framework in NR, in current NR, QCL framework is specified without any specific consideration whether the waveform is CP-OFDM or DFT-s-OFDM. As a result, if multiple waveforms are expected to be specified and dynamically switched in both DL and UL, then enhancements to current QCL framework would be essential.

Regarding antenna ports QCL, the UE can be configured with a list of up to M TCI-State configurations within the higher layer parameter PDSCH-Config to decode physical downlink shared channel (“PDSCH”) according to a detected PDCCH with downlink control information (“DCI”) intended for the UE and the given serving cell, where M depends on the UE capability maxNumberConfiguredTCIstatesPerCC. Each TCI-State contains parameters for configuring a quasi-co-location relationship between one or two downlink reference signals and the demodulation RS (“DM-RS”) ports of the PDSCH, the DM-RS port of physical downlink control channel (“PDCCH”) or the channel state information-RS (“CSI-RS”) port(s) of a CSI-RS resource. The QCL relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:
‘typeA’: {Doppler shift, Doppler spread, average delay, delay spread}
‘typeB’: {Doppler shift, Doppler spread}
‘typeC’: {Doppler shift, average delay}
‘typeD’: {Spatial Rx parameter}

The UE receives an activation command, as described in clause 6.1.3.14 of TS 38.321, used to map up to 8 TCI states to the codepoints of the DCI field ‘Transmission Configuration Indication’ in one component carrier (“CC”)/DL bandwidth part (“BWP”) or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, e.g., as described in clause 6.1.3.24 of TS 38.321, the activation command is used to map up to 8 combinations of one or two TCI states to the codepoints of the DCI field ‘Transmission Configuration Indication’. The UE is not expected to receive more than 8 TCI states in the activation command.

When the DCI field ‘Transmission Configuration Indication’ is present in DCI format 1_2 and when the number of codepoints S in the DCI field ‘Transmission Configuration Indication’ of DCI format 1_2 is smaller than the number of TCI codepoints that are activated by the activation command, e.g., as described in clauses 6.1.3.14 and 6.1.3.24 of TS38.321, only the first S activated codepoints are applied for DCI format 1_2.

When the UE would transmit a physical uplink control channel (“PUCCH”) with hybrid automatic repeat request acknowledgement (“HARQ-ACK”) information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the subcarrier spacing (“SCS”) configuration for the PUCCH. If tci-PresentInDCI is set to ‘enabled’ or tci-PresentDCI-1-2 is configured for the control resource set (“CORESET”) scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the synchronization signal (“SS”)/physical broadcast channel (“PBCH”) block determined in the initial access procedure with respect to qcl-Type set to ‘typeA’, and when applicable, also with respect to qcl-Type set to ‘typeD’.

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentDCI-1-2 for the CORESET scheduling the PDSCH, the UE assumes that the TCI field with a DCI field size indicated by tci-PresentDCI-1-2 is present in the DCI format 1_2 of the PDCCH transmitted on the CORESET. If the PDSCH is scheduled by a DCI format not having the TCI field present, and the time offset between the reception of the DL DCI and the corresponding PDSCH of a serving cell is equal to or greater than a threshold timeDurationForQCL if applicable, where the threshold is based on reported UE capability, e.g., as discussed in TS 38.306, for determining PDSCH antenna port quasi co-location, the UE assumes that the TCI state or the QCL assumption for the PDSCH is identical to the TCI state or QCL assumption whichever is applied for the CORESET used for the PDCCH transmission within the active BWP of the serving cell.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability, e.g., as discussed in TS 38.306.

When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling and the UE is not configured with enableDefaultBeamForCCS, the UE expects tci-PresentInDCI is set as ‘enabled’ or tci-PresentDCI-1-2 is configured for the CORESET, and if one or more of the TCI states configured for the serving cell scheduled by the search space set contains qcl-Type set to ‘typeD’, the UE expects the time offset between the reception of the detected PDCCH in the search space set and the corresponding PDSCH is larger than or equal to the threshold time DurationForQCL.

Independent of the configuration of tci-PresentInDCI and tci-PresentDCI-1-2 in RRC connected mode, if the offset between the reception of the DL DCI and the corresponding PDSCH is less than the threshold timeDurationForQCL and at least one configured TCI state for the serving cell of scheduled PDSCH contains qcl-Type set to ‘typeD’,
the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetId in the latest slot in which one or more CORESETs within the active BWP of the serving cell are monitored by the UE. In this case, if the qcl-Type is set to ‘typeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
If a UE is configured with enableDefaultTCIStatePerCoresetPoolIndex and the UE is configured by higher layer parameter PDCCH-Config that contains two different values of coresetPoolIndex in different ControlResourceSets,
   the UE may assume that the DM-RS ports of PDSCH associated with a value of coresetPoolIndex of a serving cell are quasi co-located with the RS(s) with respect to the QCL parameter(s) used for PDCCH quasi co-location indication of the CORESET associated with a monitored search space with the lowest controlResourceSetId among CORESETs, which are configured with the same value of coresetPoolIndex as the PDCCH scheduling that PDSCH, in the latest slot in which one or more CORESETs associated with the same value of coresetPoolIndex as the PDCCH scheduling that PDSCH within the active BWP of the serving cell are monitored by the UE. In this case, if the ‘QCL-TypeD’ of the PDSCH DM-RS is different from that of the PDCCH DM-RS with which they overlap in at least one symbol and they are associated with same coresetPoolIndex, the UE is expected to prioritize the reception of PDCCH associated with that CORESET. This also applies to the intra-band CA case (when PDSCH and the CORESET are in different component carriers).
If a UE is configured with enableTwoDefaultTCI-States, and at least one TCI codepoint indicates two TCI states, the UE may assume that the DM-RS ports of PDSCH or PDSCH transmission occasions of a serving cell are quasi co-located with the RS(s) with respect to the QCL parameter(s) associated with the TCI states corresponding to the lowest codepoint among the TCI codepoints containing two different TCI states. When the UE is configured by higher layer parameter repetitionScheme set to ‘tdmSchemeA’ or is configured with higher layer parameter repetitionNumber, the mapping of the TCI states to PDSCH transmission occasions is determined according to clause 5.1.2.1 by replacing the indicated TCI states with the TCI states corresponding to the lowest codepoint among the TCI codepoints containing two different TCI states based on the activated TCI states in the slot with the first PDSCH transmission occasion. In this case, if the ‘QCL-TypeD’ in both of the TCI states corresponding to the lowest codepoint among the TCI codepoints containing two different TCI states is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers).
In all cases above, if none of configured TCI states for the serving cell of scheduled PDSCH is configured with qcl-Type set to ‘typeD’, the UE shall obtain the other QCL assumptions from the indicated TCI states for its scheduled PDSCH irrespective of the time offset between the reception of the DL DCI and the corresponding PDSCH.

If the PDCCH carrying the scheduling DCI is received on one CC, and the PDSCH scheduled by that DCI is on another CC and the UE is configured with enable DefaultBeam-ForCCS:
The timeDurationForQCL is determined based on the subcarrier spacing of the scheduled PDSCH. If μ_{PDCCH}<μ_{PDSCH} an additional timing delay d2^{μ}PDCCH/2^{μ}PDSCH added to the timeDurationForQCL, e.g., where d is defined in 5.2.1.5.1a-1, otherwise d is zero;
For both the cases, when the offset between the reception of the DL DCI and the corresponding PDSCH is less than the threshold timeDurationForQCL, and when the DL DCI does not have the TCI field present, the UE obtains its QCL assumption for the scheduled PDSCH from the activated TCI state with the lowest ID applicable to PDSCH in the active BWP of the scheduled cell.

For a periodic CSI-RS resource in a non-zero power (“NZP”)-CSI-RS-ResourceSet configured with higher layer parameter trs-Info, the UE shall expect that a TCI-State indicates one of the following quasi co-location type(s):
‘typeC’ with an SS/PBCH block and, when applicable, ‘typeD’ with the same SS/PBCH block, or
‘typeC’ with an SS/PBCH block and, when applicable, ‘typeD’ with a CSI-RS resource in an NZP-CSI-RS-ResourceSet configured with higher layer parameter repetition, or

For an aperiodic CSI-RS resource in an NZP-CSI-RS-ResourceSet configured with higher layer parameter trs-Info, the UE shall expect that a TCI-State indicates qcl-Type set to ‘typeA’ with a periodic CSI-RS resource in an NZP-CSI-RS-ResourceSet configured with higher layer parameter trs-Info and, when applicable, qcl-Type set to ‘typeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with an SS/PBCH block, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeB’ with a CSI-RS resource in an NZP-CSI-RS-ResourceSet configured with higher layer parameter trs-Info when ‘typeD’ is not applicable.

For a CSI-RS resource in an NZP-CSI-RS-ResourceSet configured with higher layer parameter repetition, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or.
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeC’ with an SS/PBCH block and, when applicable, ‘typeD’ with the same SS/PBCH block.

For the DM-RS of PDCCH, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
‘typeA’ with a CSI-RS resource in an NZP-CSI-RS-ResourceSet configured without higher layer parameter trs-Info and without higher layer parameter repetition and, when applicable, ‘typeD’ with the same CSI-RS resource.

For the DM-RS of PDSCH, the UE shall expect that a TCI-State indicates one of the following quasi co-location type(s):
‘typeA’ with a CSI-RS resource in an NZP-CSI-RS-ResourceSet configured with higher layer parameter trs-Info and, when applicable, ‘typeD’ with the same CSI-RS resource, or
‘typeA’ with a CSI-RS resource in an NZP-CSI-RS-ResourceSet configured with higher layer parameter trs-Info and, when applicable, ‘typeD’ with a CSI-RS resource in an NZP-CSI-RS-ResourceSet configured with higher layer parameter repetition, or
typeA′ with a CSI-RS resource in an NZP-CSI-RS-ResourceSet configured without higher layer parameter trs-Info and without higher layer parameter repetition and, when applicable, ‘typeD’ with the same CSI-RS resource.

Regarding CSI framework in NR, currently in NR, the CSI framework and reporting procedure is not specified according to specific waveform since only CP-OFDM based DL is supported. According to clause 5.2.1 in 3GPP TS 38.214 V16.4.0, CSI framework is defined as follows:

The procedures on aperiodic CSI reporting described in this clause assume that the CSI reporting is triggered by DCI format 0_1, but they equally apply to CSI reporting triggered by DCI format 0_2, by applying the higher layer parameter reportTriggerSizeDCI-0-2 instead of reportTriggerSize.

The time and frequency resources that can be used by the UE to report CSI are controlled by the gNB. CSI may consist of Channel Quality Indicator (“CQI”), precoding matrix indicator (“PMI”), CSI-RS resource indicator (“CRI”), SS/PBCH Block Resource indicator (“SSBRI”), layer indicator (“LI”), rank indicator (“RI”), L1-reference signal received power (“RSRP”) or L1-signal to interference noise ratio (“SINR”).

For CQI, PMI, CRI, SSBRI, LI, RI, L1-RSRP, L1-SINR a UE is configured by higher layers with N≥1 CSI-ReportConfig Reporting Settings, M≥1 CSI-ResourceConfig Resource Settings, and one or two list(s) of trigger states (given by the higher layer parameters CSI-AperiodicTriggerStateList and CSI-SemiPersistentOnPUSCH-TriggerStateList). Each trigger state in CSI-AperiodicTriggerStateList contains a list of associated CSI-ReportConfigs indicating the Resource Set IDs for channel and optionally for interference. Each trigger state in CSI-SemiPersistentOnPUSCH-TriggerStateList contains one associated CSI-ReportConfig.

Each Reporting Setting CSI-ReportConfig is associated with a single downlink BWP (indicated by higher layer parameter BWP-Id) given in the associated CSI-ResourceConfig for channel measurement and contains the parameter(s) for one CSI reporting band: codebook configuration including codebook subset restriction, time-domain behavior, frequency granularity for CQI and PMI, measurement restriction configurations, and the CSI-related quantities to be reported by the UE such as the layer indicator (LI), L1-RSRP, L1-SINR, CRI, and SSBRI (SSB Resource Indicator).

The time domain behavior of the CSI-ReportConfig is indicated by the higher layer parameter reportConfigType and can be set to ‘aperiodic’, ‘semiPersistentOnPUCCH’, ‘semiPersistentOnPUSCH’, or ‘periodic’. For ‘periodic’ and ‘semiPersistentOnPUCCH’/‘semiPersistentOnPUSCH’ CSI reporting, the configured periodicity and slot offset applies in the numerology of the UL BWP in which the CSI report is configured to be transmitted on. The higher layer parameter reportQuantity indicates the CSI-related, L1-RSRP-related, or L1-SINR-related quantities to report. The reportFreqConfiguration indicates the reporting granularity in the frequency domain, including the CSI reporting band and if PMI/CQI reporting is wideband or sub-band. The timeRestrictionForChannelMeasurements parameter in CSI-ReportConfig can be configured to enable time domain restriction for channel measurements and timeRestrictionForInterferenceMeasurements can be configured to enable time domain interference measurements. The CSI-ReportConfig can also contain restriction for CodebookConfig, which contains configuration parameters for Type-I, Type II or Enhanced Type II CSI including codebook subset restriction, and configurations of group-based reporting.

Each CSI Resource Setting CSI-ResourceConfig contains a configuration of a list of S≥1 CSI Resource Sets (given by higher layer parameter csi-RS-ResourceSetList), where the list is comprised of references to either or both of NZP CSI-RS resource set(s) and SS/PBCH block set(s) or the list is comprised of references to CSI-interference measurement (“IM”) resource set(s). Each CSI Resource Setting is located in the DL BWP identified by the higher layer parameter BWP-id, and all CSI Resource Settings linked to a CSI Report Setting have the same DL BWP.

The time domain behavior of the CSI-RS resources within a CSI Resource Setting are indicated by the higher layer parameter resourceType and can be set to aperiodic, periodic, or semi-persistent. For periodic and semi-persistent CSI Resource Settings, the number of CSI-RS Resource Sets configured is limited to S=1. For periodic and semi-persistent CSI Resource Settings, the configured periodicity and slot offset is given in the numerology of its associated DL BWP, as given by BWP-id. When a UE is configured with multiple CSI-ResourceConfigs consisting of the same NZP CSI-RS resource ID, the same time domain behavior shall be configured for the CSI-ResourceConfigs. When a UE is configured with multiple CSI-ResourceConfigs consisting of the same CSI-IM resource ID, the same time-domain behavior shall be configured for the CSI-ResourceConfigs. All CSI Resource Settings linked to a CSI Report Setting shall have the same time domain behavior.

The following are configured via higher layer signaling for one or more CSI Resource Settings for channel and interference measurement:
CSI-IM resource for interference measurement, e.g., as described in Clause 5.2.2.4.
NZP CSI-RS resource for interference measurement, e.g., as described in Clause 5.2.2.3.1.
NZP CSI-RS resource for channel measurement, e.g., as described in Clause 5.2.2.3.1.

The UE may assume that the NZP CSI-RS resource(s) for channel measurement and the CSI-IM resource(s) for interference measurement configured for one CSI reporting are resource-wise QCLed with respect to ‘typeD’. When NZP CSI-RS resource(s) is used for interference measurement, the UE may assume that the NZP CSI-RS resource for channel measurement and the CSI-IM resource or NZP CSI-RS resource(s) for interference measurement configured for one CSI reporting are QCLed with respect to ‘typeD’.

For L1-SINR measurement:
When one Resource Setting is configured, the Resource Setting (given by higher layer parameter resourcesForChannelMeasurement) is for channel and interference measurement on NZP CSI-RS for L1-SINR computation. UE may assume that same 1 port NZP CSI-RS resource(s) with density 3 REs/RB is used for both channel and interference measurements.
When two Resource Settings are configured, the first one Resource Setting (given by higher layer parameter resourcesForChannelMeasurement) is for channel measurement on synchronization signal block (“SSB”) or NZP CSI-RS and the second one (given by either higher layer parameter csi-IM-ResourcesForInterference or parameter nzp-CSI-RS-higher layer ResourcesForInterference) is for interference measurement performed on CSI-IM or on 1 port NZP CSI-RS with density 3 resource elements (“REs”)/resource blocks (“RBs”), where each SSB or NZP CSI-RS resource for channel measurement is associated with one CSI-IM resource or one NZP CSI-RS resource for interference measurement by the ordering of the SSB or NZP CSI-RS resource for channel measurement and CSI-IM resource or NZP CSI-RS resource for interference measurement in the corresponding resource sets. The number of SSB(s) or CSI-RS resources for channel measurement equals to the number of CSI-IM resources or the number of NZP CSI-RS resource for interference measurement.
UE may apply the SSB, or ‘typeD’ RS configured with qcl-Type set to ‘typeD’ to the NZP CSI-RS resource for channel measurement, as the reference RS for determining ‘typeD’ assumption for the corresponding CSI-IM resource or the corresponding NZP CSI-RS resource for interference measurement configured for one CSI reporting.
UE may expect that the NZP CSI-RS resource set for channel measurement and the NZP-CSI-RS resource set for interference measurement, if any, are configured with the higher layer parameter repetition.

In this disclosure, when multiple waveforms can be supported for downlink and/or uplink, the QCL assumption framework is enhanced such that the source reference signal(s) that is indicated to be quasi-collocated with the target (RS) transmission(s) by TCI state are expected to be associated with the same waveform type. The transmission/reception parameters may be affected by beam gain, path loss, delay spread, etc. that can vary depending up on whether a single carrier waveform such as SC-FDE is applied or a multi-carrier waveform such as CP-OFDM is applied. Therefore, application of the restriction of the same waveform type for both source RS(s) and target RS(s) would be needed to have a valid QCL assumption, which is currently not the case in NR.

According to a first embodiment directed to waveform-specific QCL assumption between one source RS and one target RS, the UE can be configured by the network with a TCI state indicating the source RS that is QCLed with a target RS transmission such that both the source RS and the target RS are associated with same waveform. In one example, the source RS is a CSI-RS resource that has been received by the UE using single carrier waveform and therefore the target RS that is QCLed is also expected by the UE to be received with a single carrier waveform.

In one implementation, if the waveform type associated with the source RS is different from the waveform type associated with the target RS, then the indicated QCL assumption for the target RS is not applied at the UE and the previous QCL assumption used for the target RS is applied. In some implementations, if the UE receives PDCCH with one TCI state, but the TCI indication in the DCI (contained in the PDCCH) indicates a dynamic update for the QCL assumption to receive the PDSCH (DM-RS), but the waveform associated with source RS is different than the waveform indicated to the receiver PDSCH (DM-RS), then the UE is not required to update the TCI state (QCL assumption indicated in DCI), but continues to use the same TCI state (QCL assumption) used to receive the PDSCH. Similar implementations may also be applicable to transmission/reception of other channels/signals such PUSCH, PUCCH, sounding reference signal (“SRS”), SSB, and/or the like.

In some embodiments, the waveform specific QCL assumption is applicable to QCL assumption type-A, B, C, D, or some combination thereof.

According to a second embodiment directed to waveform-specific QCL assumption between multiple source RSs and one target RS, when the TCI state indicates at least two source RS corresponding to two different QCL assumption types and a single target RS, then the each of the QCL assumption is applied for target RS only when the waveform associated with the given source RS is same as the waveform associated with target RS.

In one implementation, a TCI state is indicated to the UE with two source RS, where one source RS is an SSB RS (associated with CP-OFDM) and QCL type-A and another source RS is a CSI-RS (associated with SC-FDE) and QCL type-D. The target RS is PDSCH DM-RS, and it is associated with SC-FDE. In such an embodiment, the UE will update only the QCL type-D assumption because the source RS and target RS in this assumption are associated with the same waveform. However, for QCL type-A assumption, the UE will not update and use one of the existing/previous QCL type-A assumptions because the associated waveform in the indicated TCI state with corresponding RS is different than the waveform associated with the target RS. In an alternate embodiment, none of the two QCL assumption types are updated even if one of the source RSs is associated with a waveform different than the waveform associated with the target RS. Alternatively, all the source RSs indicated by the TCI should have the same waveform as the target RS to apply/update the QCL assumptions for the target RS.

In another embodiment, when the TCI state indicates at least two source RSs corresponding to two same QCL assumption types that are associated with two different waveforms and a single target RS, then the QCL assumption is applied according to the source RS that has the same waveform as the waveform associated with the target RS. In one implementation, a TCI state is indicated to the UE with two source RSs, where one source RS is an SSB RS (associated with CP-OFDM) and QCL type-D and another source RS is a CSI-RS (associated with SC-FDE) and QCL type-D. The target RS is PDSCH DM-RS, and it is associated with SC-FDE. In such an embodiment, the UE will update only the QCL type-D assumption according to CSI-RS as source RS.

It is noted that, in one embodiment, multiple source RSs implies two or more source RSs, even though in above description two source RSs are indicated.

According to a third embodiment directed to waveform-specific QCL assumption between multiple source RSs and one target RS with repetition, when the TCI state indicates at least two source RSs corresponding to two of the same QCL assumption types that are associated with two different waveforms and a single target RS, and where the target RS is scheduled for at least two transmissions/repetitions, then the first instance of the target RS transmission applies the first QCL assumption associated with first waveform and the second instance of the target RS applies the second QCL assumption associated with the second waveform. Alternatively, in one embodiment, two TCI states may be indicated instead of two source RSs (with the same QCL types) within one TCI state. In one implementation, when more than two transmissions/repetitions of the target RS are scheduled, then the pattern for switching waveforms corresponding to two source RSs can be pre-configured, semi-statically configured, dynamically indicated, or some combination thereof.

According to a fourth embodiment directed to enhanced QCL assumption with waveform indication, enhanced TCI state indication is proposed that indicates at least one source RS for QCL assumption and the waveform indication that are to be applied for the target RS transmission/reception. In one implementation, RRC is used to configure the UE with N number of TCI states indicating a source RS with QCL assumption and additionally with one of the waveforms that is supported by the UE. Then, in one embodiment, the MAC CE can be used to activate M number of TCI states (M<=N), from which the one TCI state can be indicated to the UE. Consequently, the UE determines the QCL assumption to be applied for the target RS transmission (UL)/reception (DL) and the corresponding waveform to be applied.

In an alternate implementation, RRC is used to configure the UE with N number of TCI states indicating a source RS with QCL assumption. Following RRC configuration, MAC CE can be used to activate M number of TCI states (M<=N) and additionally associate each of the states with a waveform. Following MAC CE activation, in one embodiment, one TCI state can be indicated to the UE. Consequently, the UE determines the QCL assumption to be applied for a target RS transmission (UL)/reception (DL) and the corresponding waveform to be applied.

According to a fifth embodiment 5 directed to waveform-specific QCL assumption with unified TCI framework (DL and UL), the UE is configured with unified TCI e.g., at least one source RS associated with one QCL assumption is indicated for each of downlink and uplink target RS transmission, wherein one source RS (corresponding to DL) is associated with one waveform and the other source RS (corresponding to UL) is associated with a second waveform. In such an embodiment, the QCL assumption corresponding to the source RS (for DL) is applied to the target RS (for DL) when the waveform is the same between that source RS (for DL) and the target RS (for DL). Similarly, in one embodiment, the QCL assumption corresponding to the source RS (for UL) is applied to the target RS (for UL) when the waveform is the same between that source RS (for UL) and target RS (for UL).

In another embodiment, one source RS for QCL assumption is indicated by the TCI state for application for both DL and UL target RSs, where the source RS is associated with one waveform. In such an embodiment, the QCL assumption is updated for DL if the waveform is the same between that source RS and the target RS (for DL). Similarly, the QCL assumption corresponding to the source RS is applied to the target RS (for UL) when the waveform is the same between that source RS and the target RS (for UL). This may imply that, depending upon the waveform association, QCL assumption may apply to DL and UL, only DL, only UL, or neither DL nor UL.

In an alternate embodiment, the QCL assumption is either applied to both DL and UL or neither of DL nor UL depending upon the waveform between the source RS and the target RS for DL and UL.

In another embodiment, enhanced TCI indication is proposed where the source RS is indicated for QCL assumption to be applied at both UL and DL and, additionally, the TCI state also indicates which waveform to apply for both DL and UL. In such an embodiment, this waveform indication in the TCI state overrides any other semi-static and/or prior indication of the waveform to be applied. In one implementation, the TCI state can indicate one source RS for DL, one source RS for UL, a target RS for DL and a target RS for UL, and one waveform indication for DL and another waveform indication for UL.

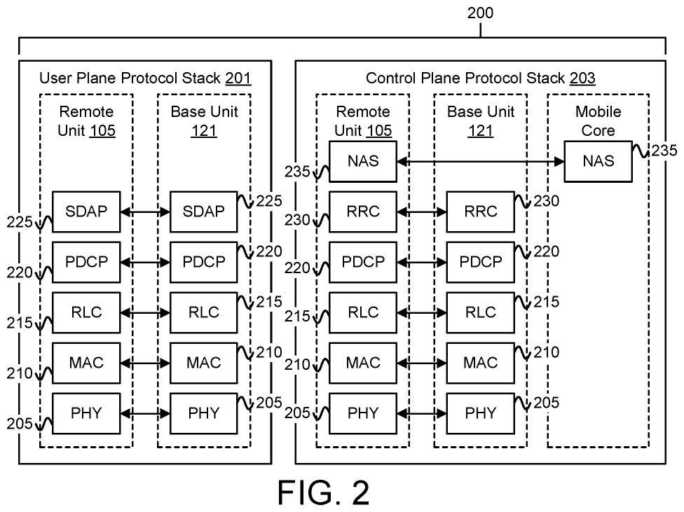

FIG. 2 depicts a NR protocol stack 200, according to embodiments of the disclosure. While FIG. 2 shows the remote unit 105, the base unit 121 and the mobile core network 130, these are representative of a set of UEs interacting with a RAN node and a NF (e.g., AMF) in a core network. As depicted, the protocol stack 200 comprises a User Plane protocol stack 201 and a Control Plane protocol stack 203. The User Plane protocol stack 201 includes a physical (“PHY”) layer 205, a Medium Access Control (“MAC”) sublayer 210, a Radio Link Control (“RLC”) sublayer 215, a Packet Data Convergence Protocol (“PDCP”) sublayer 220, and a Service Data Adaptation Protocol (“SDAP”) layer 225. The Control Plane protocol stack 203 also includes a physical layer 205, a MAC sublayer 210, an RLC sublayer 215, and a PDCP sublayer 220. The Control Place protocol stack 203 also includes a Radio Resource Control (“RRC”) sublayer 230 and a Non-Access Stratum (“NAS”) sublayer 235.

The AS protocol stack for the Control Plane protocol stack 203 consists of at least RRC, PDCP, RLC and MAC sublayers, and the physical layer. The AS protocol stack for the User Plane protocol stack 201 consists of at least SDAP, PDCP, RLC and MAC sublayers, and the physical layer. The Layer-2 (“L2”) is split into the SDAP, PDCP, RLC and MAC sublayers. The Layer-3 (“L3”) includes the RRC sublayer 230 and the NAS layer 235 for the control plane and includes, e.g., an Internet Protocol (“IP”) layer or PDU Layer (note depicted) for the user plane. L1 and L2 are referred to as “lower layers” such as PUCCH/PUSCH or MAC CE, while L3 and above (e.g., transport layer, application layer) are referred to as “higher layers” or “upper layers” such as RRC.

The physical layer 205 offers transport channels to the MAC sublayer 210. The MAC sublayer 210 offers logical channels to the RLC sublayer 215. The RLC sublayer 215 offers RLC channels to the PDCP sublayer 220. The PDCP sublayer 220 offers radio bearers to the SDAP sublayer 225 and/or RRC sublayer 230. The SDAP sublayer 225 offers QoS flows to the mobile core network 130 (e.g., 5GC). The RRC sublayer 230 provides for the addition, modification, and release of Carrier Aggregation and/or Dual Connectivity. The RRC sublayer 230 also manages the establishment, configuration, maintenance, and release of Signaling Radio Bearers (“SRBs”) and Data Radio Bearers (“DRBs”). In certain embodiments, an RRC entity functions for detection of and recovery from radio link failure.

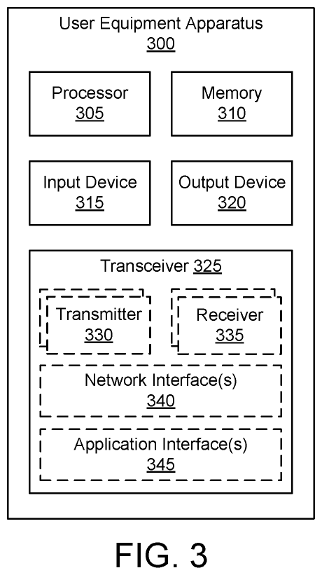

FIG. 3 depicts a user equipment apparatus 300 that may be used for multiple waveforms based QCL/TCI framework, according to embodiments of the disclosure. In various embodiments, the user equipment apparatus 300 is used to implement one or more of the solutions described above. The user equipment apparatus 300 may be one embodiment of a UE, such as the remote unit 105 and/or the UE 205, as described above. Furthermore, the user equipment apparatus 300 may include a processor 305, a memory 310, an input device 315, an output device 320, and a transceiver 325. In some embodiments, the input device 315 and the output device 320 are combined into a single device, such as a touchscreen. In certain embodiments, the user equipment apparatus 300 may not include any input device 315 and/or output device 320. In various embodiments, the user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more base units 121. Additionally, the transceiver 325 may support at least one network interface 340 and/or application interface 345. The application interface(s) 345 may support one or more APIs. The network interface(s) 340 may support 3GPP reference points, such as Uu and PC5. Other network interfaces 340 may be supported, as understood by one of ordinary skill in the art.

The processor 305, in one embodiment, may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 305 executes instructions stored in the memory 310 to perform the methods and routines described herein. The processor 305 is communicatively coupled to the memory 310, the input device 315, the output device 320, and the transceiver 325. In certain embodiments, the processor 305 may include an application processor (also known as “main processor”) which manages application-domain and operating system (“OS”) functions and a baseband processor (also known as “baseband radio processor”) which manages radio functions.

The memory 310, in one embodiment, is a computer readable storage medium. In some embodiments, the memory 310 includes volatile computer storage media. For example, the memory 310 may include a RAM, including dynamic RAM (“DRAM”), synchronous dynamic RAM (“SDRAM”), and/or static RAM (“SRAM”). In some embodiments, the memory 310 includes non-volatile computer storage media. For example, the memory 310 may include a hard disk drive, a flash memory, or any other suitable non-volatile computer storage device. In some embodiments, the memory 310 includes both volatile and non-volatile computer storage media.

In some embodiments, the memory 310 stores data related to CSI enhancements for higher frequencies. For example, the memory 310 may store parameters, configurations, resource assignments, policies, and the like as described above. In certain embodiments, the memory 310 also stores program code and related data, such as an operating system or other controller algorithms operating on the user equipment apparatus 300, and one or more software applications.

The input device 315, in one embodiment, may include any known computer input device including a touch panel, a button, a keyboard, a stylus, a microphone, or the like. In some embodiments, the input device 315 may be integrated with the output device 320, for example, as a touchscreen or similar touch-sensitive display. In some embodiments, the input device 315 includes a touchscreen such that text may be input using a virtual keyboard displayed on the touchscreen and/or by handwriting on the touchscreen. In some embodiments, the input device 315 includes two or more different devices, such as a keyboard and a touch panel.

The output device 320, in one embodiment, is designed to output visual, audible, and/or haptic signals. In some embodiments, the output device 320 includes an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

In certain embodiments, the output device 320 includes one or more speakers for producing sound. For example, the output device 320 may produce an audible alert or notification (e.g., a beep or chime). In some embodiments, the output device 320 includes one or more haptic devices for producing vibrations, motion, or other haptic feedback. In some embodiments, all, or portions of the output device 320 may be integrated with the input device 315. For example, the input device 315 and output device 320 may form a touchscreen or similar touch-sensitive display. In other embodiments, the output device 320 may be located near the input device 315.

The transceiver 325 includes at least transmitter 330 and at least one receiver 335. The transceiver 325 may be used to provide UL communication signals to a base unit 121 and to receive DL communication signals from the base unit 121, as described herein. Similarly, the transceiver 325 may be used to transmit and receive SL signals (e.g., V2X communication), as described herein. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. In one embodiment, the transceiver 325 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

In various embodiments, one or more transmitters 330 and/or one or more receivers 335 may be implemented and/or integrated into a single hardware component, such as a multi-transceiver chip, a system-on-a-chip, an ASIC, or other type of hardware component. In certain embodiments, one or more transmitters 330 and/or one or more receivers 335 may be implemented and/or integrated into a multi-chip module. In some embodiments, other components such as the network interface 340 or other hardware components/circuits may be integrated with any number of transmitters 330 and/or receivers 335 into a single chip. In such embodiment, the transmitters 330 and receivers 335 may be logically configured as a transceiver 325 that uses one more common control signals or as modular transmitters 330 and receivers 335 implemented in the same hardware chip or in a multi-chip module.

In one embodiment, the transceiver 325 and the processor 305 are configured to receive signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the processor 305 is configured to cause the apparatus to apply the QCL information at the apparatus based on the one or more waveforms associated with the at least one source RS and the at least one target RS.

In one embodiment, a waveform associated with the at least one source RS and a waveform associated with the at least one target RS are the same in the QCL information.

In one embodiment, the processor 305 is configured to use a waveform associated with the at least one source RS for transmission and reception of the at least one target RS in response to the waveform associated with the source RS being different from a waveform associated with the at least one target RS.

In one embodiment, the processor 305 is configured to receive, via the transceiver 325, at least two QCL assumptions that are indicated to the apparatus, the first QCL assumption associated with a first waveform type and a second QCL assumption associated with a second waveform type.

In one embodiment, the processor 305 is configured to select one of the two QCL assumptions, the waveform associated with the at least one source RS being the same as the waveform associated with target RS for the selected one of the two QCL assumptions.

In one embodiment, the processor 305 is configured to schedule at least two instances of the at least one target RS transmission or reception, the first instance associated with the first waveform type and the second instance associated with the second waveform type.

In one embodiment, a TCI indicates, to the at least one target RS, the at least one source RS, a QCL assumption type, and a waveform to be used for transmission or reception of the at least one target RS.

In one embodiment, at least two source RSs are indicated, each of the indicated source RSs associated with a waveform such that a first source RS of the at least two source RSs is used to indicate QCL assumption and a corresponding waveform for uplink and a second source RS of the at least two source RSs is used to indicate QCL assumption and a corresponding waveform for downlink.

In one embodiment, at least two source RSs are indicated, the at least two RSs associated with a waveform, a first source RS of the at least two source RSs is used to indicate QCL assumption for uplink and a second source RS of the at least two source RSs is used to indicate QCL assumption for downlink, the associated waveform used for both uplink and downlink.

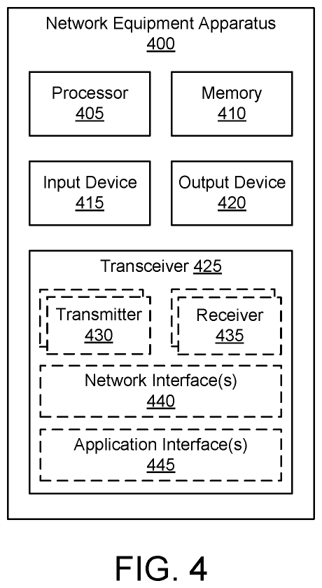

FIG. 4 depicts one embodiment of a network apparatus 400 that may be used for multiple waveforms based QCL/TCI framework, according to embodiments of the disclosure. In some embodiments, the network apparatus 400 may be one embodiment of a RAN node and its supporting hardware, such as the base unit 121 and/or gNB, described above. Furthermore, network apparatus 400 may include a processor 405, a memory 410, an input device 415, an output device 420, and a transceiver 425. In certain embodiments, the network apparatus 400 does not include any input device 415 and/or output device 420.

As depicted, the transceiver 425 includes at least one transmitter 430 and at least one receiver 435. Here, the transceiver 425 communicates with one or more remote units 105. Additionally, the transceiver 425 may support at least one network interface 440 and/or application interface 445. The application interface(s) 445 may support one or more APIs. The network interface(s) 440 may support 3GPP reference points, such as Uu, N1, N2, N3, N5, N6 and/or N7 interfaces. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), a digital signal processor (“DSP”), a co-processor, an application-specific processor, or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio function. In various embodiments, the processor 405 controls the network apparatus 400 to implement the above described network entity behaviors (e.g., of the gNB) for multiple waveforms based QCL/TCI framework.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data relating to CSI enhancements for higher frequencies. For example, the memory 410 may store parameters, configurations, resource assignments, policies, and the like as described above. In certain embodiments, the memory 410 also stores program code and related data, such as an operating system (“OS”) or other controller algorithms operating on the network apparatus 400, and one or more software applications.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, may include any known electronically controllable display or display device. The output device 420 may be designed to output visual, audible, and/or haptic signals. In some embodiments, the output device 420 includes an electronic display capable of outputting visual data to a user. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, all, or portions of the output device 420 may be located near the input device 415.

As discussed above, the transceiver 425 may communicate with one or more remote units and/or with one or more interworking functions that provide access to one or more PLMNs. The transceiver 425 may also communicate with one or more network functions (e.g., in the mobile core network 80). The transceiver 425 operates under the control of the processor 405 to transmit messages, data, and other signals and also to receive messages, data, and other signals. For example, the processor 405 may selectively activate the transceiver (or portions thereof) at particular times in order to send and receive messages.

The transceiver 425 may include one or more transmitters 430 and one or more receivers 435. In certain embodiments, the one or more transmitters 430 and/or the one or more receivers 435 may share transceiver hardware and/or circuitry. For example, the one or more transmitters 430 and/or the one or more receivers 435 may share antenna(s), antenna tuner(s), amplifier(s), filter(s), oscillator(s), mixer(s), modulator/demodulator(s), power supply, and the like. In one embodiment, the transceiver 425 implements multiple logical transceivers using different communication protocols or protocol stacks, while using common physical hardware.

In one embodiment, the transceiver 425 and the processor 405 are configured to determine signaling information indicating QCL information comprising at least one source RS and at least one target RS for transmission to a network, reception from the network, or a combination thereof, the at least one source RS and the at least one target RS associated with one or more waveforms. In one embodiment, the processor 405 is configured to cause the apparatus to transmit the QCL information to a UE for application based on the one or more waveforms associated with the at least one source RS and the at least one target RS.

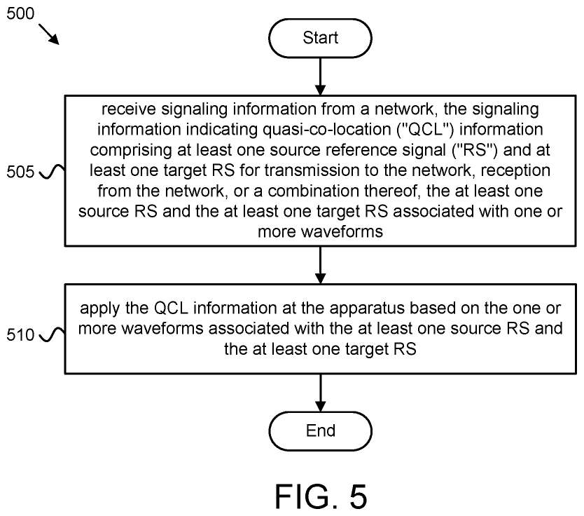

FIG. 5 is a flowchart diagram of a method 500 for multiple waveforms based QCL/TCI framework. The method 500 may be performed by a UE as described herein, for example, the remote unit 105 and/or the user equipment apparatus 300. In some embodiments, the method 500 may be performed by a processor executing program code, for example, a microcontroller, a microprocessor, a CPU, a GPU, an auxiliary processing unit, a FPGA, or the like.

In one embodiment, the method 500 begins and receives 505 signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the method 500 applies 510 the QCL information at the apparatus based on the one or more waveforms associated with the at least one source RS and the at least one target RS, and the method 500 ends.

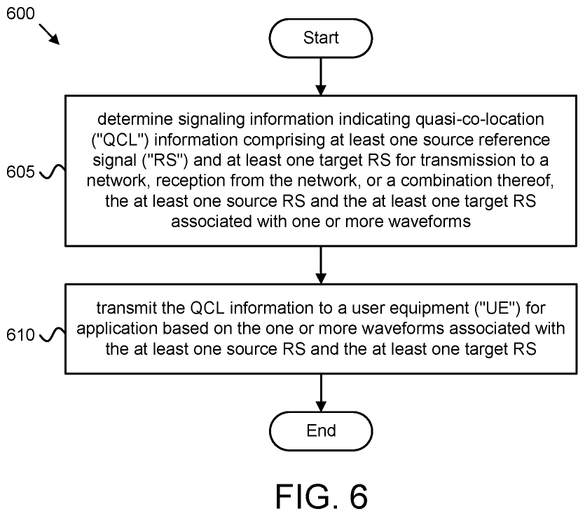

FIG. 6 is a flowchart diagram of a method 600 for multiple waveforms based QCL/TCI framework. The method 600 may be performed by a network device as described herein, for example, the gNB, the base unit 121, and/or the network equipment apparatus 400. In some embodiments, the method 600 may be performed by a processor executing program code, for example, a microcontroller, a microprocessor, a CPU, a GPU, an auxiliary processing unit, a FPGA, or the like.

In one embodiment, the method 600 begins and determines 605 signaling information indicating QCL information comprising at least one source RS and at least one target RS for transmission to a network, reception from the network, or a combination thereof, the at least one source RS and the at least one target RS associated with one or more waveforms. In one embodiment, the method 600 transmits 610 the QCL information to a UE for application based on the one or more waveforms associated with the at least one source RS and the at least one target RS, and the method 600 ends.

A first apparatus is disclosed for multiple waveforms based QCL/TCI framework. The first apparatus may include a UE as described herein, for example, the remote unit 105 and/or the user equipment apparatus 300. In some embodiments, the first apparatus may include a processor executing program code, for example, a microcontroller, a microprocessor, a CPU, a GPU, an auxiliary processing unit, a FPGA, or the like.

In one embodiment, the first apparatus includes a transceiver and a processor that is coupled to the transceiver. In one embodiment, the processor is configured to cause the apparatus to receive signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the processor is configured to cause the apparatus to apply the QCL information at the apparatus based on the one or more waveforms associated with the at least one source RS and the at least one target RS.

In one embodiment, a waveform associated with the at least one source RS and a waveform associated with the at least one target RS are the same in the QCL information.

In one embodiment, the processor is configured to cause the apparatus to use a waveform associated with the at least one source RS for transmission and reception of the at least one target RS in response to the waveform associated with the source RS being different from a waveform associated with the at least one target RS.

In one embodiment, the processor is configured to cause the apparatus to receive at least two QCL assumptions that are indicated to the apparatus, the first QCL assumption associated with a first waveform type and a second QCL assumption associated with a second waveform type.

In one embodiment, the processor is configured to cause the apparatus to select one of the two QCL assumptions, the waveform associated with the at least one source RS being the same as the waveform associated with target RS for the selected one of the two QCL assumptions.

In one embodiment, the processor is configured to cause the apparatus to schedule at least two instances of the at least one target RS transmission or reception, the first instance associated with the first waveform type and the second instance associated with the second waveform type.

In one embodiment, a TCI indicates, to the at least one target RS, the at least one source RS, a QCL assumption type, and a waveform to be used for transmission or reception of the at least one target RS.

In one embodiment, at least two source RSs are indicated, each of the indicated source RSs associated with a waveform such that a first source RS of the at least two source RSs is used to indicate QCL assumption and a corresponding waveform for uplink and a second source RS of the at least two source RSs is used to indicate QCL assumption and a corresponding waveform for downlink.

In one embodiment, at least two source RSs are indicated, the at least two RSs associated with a waveform, a first source RS of the at least two source RSs is used to indicate QCL assumption for uplink and a second source RS of the at least two source RSs is used to indicate QCL assumption for downlink, the associated waveform used for both uplink and downlink.

A first method is disclosed for multiple waveforms based QCL/TCI framework. The first method may be performed by a UE as described herein, for example, the remote unit 105 and/or the user equipment apparatus 300. In some embodiments, the first method may be performed by a processor executing program code, for example, a microcontroller, a microprocessor, a CPU, a GPU, an auxiliary processing unit, a FPGA, or the like.

In one embodiment, the first method includes receiving signaling information from a network, the signaling information indicating QCL information comprising at least one source RS and at least one target RS for transmission to the network, reception from the network, or a combination thereof, the at least one source RS and the at least one target RS associated with one or more waveforms. In one embodiment, the first method includes applying the QCL information at the apparatus based on the one or more waveforms associated with the at least one source RS and the at least one target RS.

In one embodiment, a waveform associated with the at least one source RS and a waveform associated with the at least one target RS are the same in the QCL information.

In one embodiment, the first method includes using a waveform associated with the at least one source RS for transmission and reception of the at least one target RS in response to the waveform associated with the source RS being different from a waveform associated with the at least one target RS.

In one embodiment, the first method includes receiving at least two QCL assumptions that are indicated to the apparatus, the first QCL assumption associated with a first waveform type and a second QCL assumption associated with a second waveform type.

In one embodiment, the first method includes selecting one of the two QCL assumptions, the waveform associated with the at least one source RS being the same as the waveform associated with target RS for the selected one of the two QCL assumptions.

A second apparatus is disclosed for multiple waveforms based QCL/TCI framework. The second apparatus may include a network device as described herein, for example, the gNB, the base unit 121, and/or the network equipment apparatus 400. In some embodiments, the second apparatus may include a processor executing program code, for example, a microcontroller, a microprocessor, a CPU, a GPU, an auxiliary processing unit, a FPGA, or the like.

In one embodiment, the second apparatus includes a transceiver and a processor that is coupled to the transceiver. In one embodiment, the processor is configured to cause the apparatus to determine signaling information indicating QCL information comprising at least one source RS and at least one target RS for transmission to a network, reception from the network, or a combination thereof, the at least one source RS and the at least one target RS associated with one or more waveforms. In one embodiment, the processor is configured to cause the apparatus to transmit the QCL information to a UE for application based on the one or more waveforms associated with the at least one source RS and the at least one target RS.

A second method is disclosed for multiple waveforms based QCL/TCI framework. The second method may be performed by a network device as described herein, for example, the gNB, the base unit 121, and/or the network equipment apparatus 400. In some embodiments, the second method may be performed by a processor executing program code, for example, a microcontroller, a microprocessor, a CPU, a GPU, an auxiliary processing unit, a FPGA, or the like.

In one embodiment, the second method includes determining signaling information indicating QCL information comprising at least one source RS and at least one target RS for transmission to a network, reception from the network, or a combination thereof, the at least one source RS and the at least one target RS associated with one or more waveforms. In one embodiment, the second method includes transmitting the QCL information to a UE for application based on the one or more waveforms associated with the at least one source RS and the at least one target RS.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) apparatus, comprising:
a transceiver; and
a processor coupled to the transceiver, the processor configured to cause the apparatus to:
receive signaling information from a network, the signaling information indicating quasi-co-location (“QCL”) information comprising at least one source reference signal (“RS”) and at least one target RS for transmission to the network, reception from the network, or a combination thereof, the at least one source RS and the at least one target RS associated with one or more waveforms; and
apply the QCL information at the apparatus based on the one or more waveforms associated with the at least one source RS and the at least one target RS.

2. The apparatus of claim 1, wherein a waveform associated with the at least one source RS and a waveform associated with the at least one target RS are the same in the QCL information.

3. The apparatus of claim 1, wherein the processor is configured to cause the apparatus to use a waveform associated with the at least one source RS for transmission and reception of the at least one target RS in response to the waveform associated with the source RS being different from a waveform associated with the at least one target RS.

4. The apparatus of claim 1, wherein the processor is configured to cause the apparatus to receive at least two QCL assumptions that are indicated to the apparatus, the first QCL assumption associated with a first waveform type and a second QCL assumption associated with a second waveform type.

5. The apparatus of claim 4, wherein the processor is configured to cause the apparatus to select one of the two QCL assumptions, the waveform associated with the at least one source RS being the same as the waveform associated with target RS for the selected one of the two QCL assumptions.

6. The apparatus of claim 4, wherein the processor is configured to cause the apparatus to schedule at least two instances of the at least one target RS transmission or reception, the first instance associated with the first waveform type and the second instance associated with the second waveform type.

7. The apparatus of claim 4, wherein a Transmission Configuration Indicator (“TCI”) indicates, to the at least one target RS, the at least one source RS, a QCL assumption type, and a waveform to be used for transmission or reception of the at least one target RS.

8. The apparatus of claim 1, wherein at least two source RSs are indicated, each of the indicated source RSs associated with a waveform such that a first source RS of the at least two source RSs is used to indicate QCL assumption and a corresponding waveform for uplink and a second source RS of the at least two source RSs is used to indicate QCL assumption and a corresponding waveform for downlink.

9. The apparatus of claim 1, wherein at least two source RSs are indicated, the at least two RSs associated with a waveform, a first source RS of the at least two source RSs is used to indicate QCL assumption for uplink and a second source RS of the at least two source RSs is used to indicate QCL assumption for downlink, the associated waveform used for both uplink and downlink.

10. A method of a user equipment (“UE”) apparatus, comprising:
receiving signaling information from a network, the signaling information indicating quasi-co-location (“QCL”) information comprising at least one source reference signal (“RS”) and at least one target RS for transmission to the network, reception from the network, or a combination thereof, the at least one source RS and the at least one target RS associated with one or more waveforms; and
applying the QCL information at the apparatus based on the one or more waveforms associated with the at least one source RS and the at least one target RS.

11. The method of claim 10, wherein a waveform associated with the at least one source RS and a waveform associated with the at least one target RS are the same in the QCL information.

12. The method of claim 10, further comprising using a waveform associated with the at least one source RS for transmission and reception of the at least one target RS in response to the waveform associated with the source RS being different from a waveform associated with the at least one target RS.

13. The method of claim 10, further comprising receiving at least two QCL assumptions that are indicated to the apparatus, the first QCL assumption associated with a first waveform type and a second QCL assumption associated with a second waveform type.

14. The method of claim 13, further comprising selecting one of the two QCL assumptions, the waveform associated with the at least one source RS being the same as the waveform associated with target RS for the selected one of the two QCL assumptions.

15. A network entity apparatus, comprising:
a transceiver; and
a processor coupled to the transceiver, the processor configured to cause the apparatus to:
determine signaling information indicating quasi-co-location (“QCL”) information comprising at least one source reference signal (“RS”) and at least one target RS for transmission to a network, reception from the network, or a combination thereof, the at least one source RS and the at least one target RS associated with one or more waveforms; and
transmit the QCL information to a user equipment (“UE”) for application based on the one or more waveforms associated with the at least one source RS and the at least one target RS.
